(19) United States
(12) Patent Application Publication
(10) Pub. No.: US 2010/0033382 A1
(43) Pub. Date: Feb. 11, 2010

(54) CIRCULARLY POLARIZED ANTENNA

(76) Inventor: Chih-Shen Chou, Miaoli County (TW)

Correspondence Address: NORTH AMERICA INTELLECTUAL PROPERTY CORPORATION, P.O. BOX 506, MERRIFIELD, VA, 22116, US

(21) Appl. No.: 12/269,055

(22) Filed: Nov. 12, 2008

(30) Foreign Application Priority Data
Aug. 11, 2008 (TW) 097130527

(51) Int. Cl. H01Q 1/38

(52) U.S. Cl. 343/700 MS

(57) ABSTRACT

A circularly polarized antenna includes a substrate, a signal transmission unit, a radiation electrode and a ground electrode. The substrate is made of a dielectric material and has a through hole through both a first surface and a second surface of the substrate. The signal transmission unit goes through the through hole. The radiation electrode is disposed on the first surface of the substrate. The ground electrode is disposed on the second surface of the substrate. In addition, the radiation electrode comprises a central electrode and a plurality of peripheral electrodes. The peripheral electrodes extend from the central electrode.

### BACKGROUND OF THE INVENTION

1. Field of the Invention

The present invention relates to a circularly polarized antenna, and more particularly, to a circularly polarized antenna that comprises a radiation electrode having a central electrode and a plurality of peripheral electrodes.

2. Description of the Prior Art

Please refer to FIG. 1. FIG. 1 is a structural diagram illustrating a conventional circularly polarized antenna 100. As shown in FIG. 1, the 100 comprises a substrate 110 and a metal stick 120. The substrate 110 is made of a dielectric material, such as a ceramic material, and the top and bottom surfaces of the substrate 110 are coated with metal to act as a radiation electrode 130 and a ground electrode 140, respectively. In addition, the substrate 110 includes a through hole 116 going through the top and bottom surface, and the metal stick 120 is disposed in the through hole 116 to connect the radiation electrode 130 with signal processing units (not shown in FIG. 1)

To meet the circular polarization characteristics, the radiation electrode 130 of the conventional circularly polarized antenna 100 is designed to be a nearly square shape to keep the vertical and horizontal resonant frequencies the same, and the substrate 110 is also a square shape based on the design of the radiation electrode 130. However, the standard light-weight, thinness, and small-volume requirements for modern electronic products mean that the conventional circularly polarized antenna is unable to be disposed in current electronic products, such as a wafer thin/super thin mobile phone. Thus, a linearly polarized antenna is generally used instead of the circularly polarized antenna. This means that the circular polarization characteristics of the circularly polarized antenna 100 are sacrificed.

### SUMMARY OF THE INVENTION

It is therefore one of the objectives of the present invention to provide a circularly polarized antenna with a non-square radiation electrode to solve the above-mentioned problem.

According to an exemplary embodiment of the present invention, a circularly polarized antenna is disclosed. The circularly polarized antenna comprises: a substrate, which is made of a dielectric material and has a through hole through both a first surface and a second surface of the substrate; a signal transmission unit, which goes through the through hole of the substrate; a radiation electrode, which is disposed on the first surface of the substrate, wherein the radiation electrode comprises a central electrode and a plurality of peripheral electrodes which are extended from the central electrode; and a ground electrode, which is disposed on the second surface of the substrate.

With the help of the central electrode and a plurality of peripheral electrodes extended from the central electrode, the substrate can have an oblong shape. In this manner, the circularly polarized antenna of the present invention is able to be disposed in a wafer thin mobile phone while the circular polarization characteristics are still preserved, thereby solving the problem described in the prior art.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a structural diagram illustrating a conventional circularly polarized antenna.

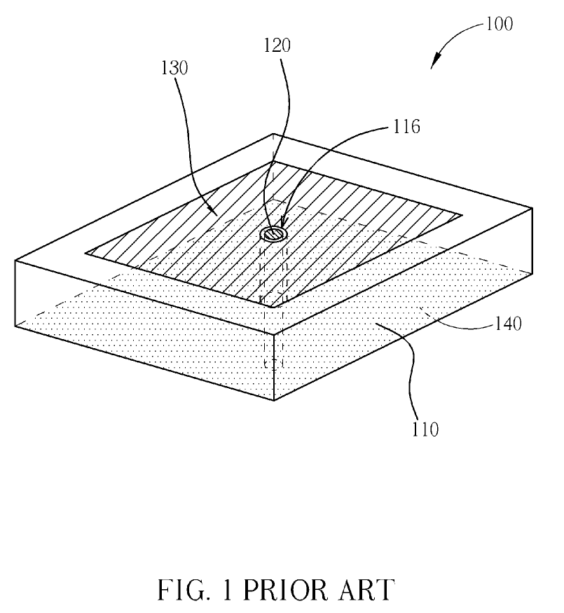

FIG. 2 is a schematic diagram illustrating a circularly polarized antenna according to a first embodiment of the present invention.

FIG. 3 is a schematic diagram illustrating a circularly polarized antenna according to a second embodiment of the present invention.

FIG. 4 is a schematic diagram illustrating a circularly polarized antenna according to a third embodiment of the present invention.

FIG. 5 is a schematic diagram illustrating a circularly polarized antenna according to a fourth embodiment of the present invention.

FIG. 6 is a schematic diagram illustrating a circularly polarized antenna according to a fifth embodiment of the present invention.

FIG. 7 is an exemplary diagram illustrating a central electrode in the shape of an X of the present invention.

FIG. 8 is another exemplary diagram illustrating a central electrode in the shape of an X of the present invention.

FIG. 9 is an exemplary diagram illustrating a circularly polarized antenna with a rectangular central electrode of the present invention.

FIG. 10 is a schematic diagram illustrating a circularly polarized antenna according to a sixth embodiment of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “electrically connect” is intended to mean either an indirect or direct electrical connection. Accordingly, if one device is coupled to another device, that connection may be through a direct electrical connection, or through an indirect electrical connection via other devices and connections.

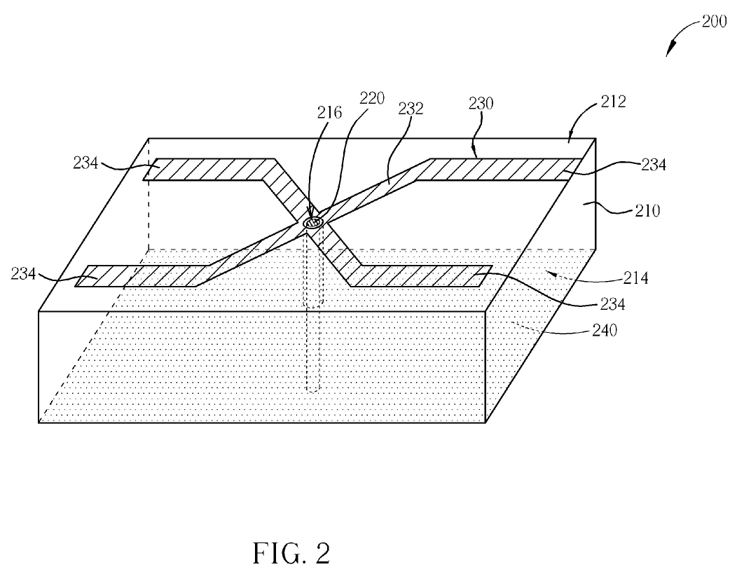

Please refer to FIG. 2. FIG. 2 is a schematic diagram illustrating a circularly polarized antenna 200 according to a first embodiment of the present invention. To make the concept of the present invention easily appreciable, the circularly polarized antenna 200 is assumed to be a patch antenna in this embodiment; this is, however, for illustrative purposes and not a limitation of the present invention.

The circularly polarized antenna 200 comprises a substrate 210, a signal transmission unit 220 (e.g. a metal stick), a radiation electrode 230 and a ground electrode 240. The substrate 210 is made of a dielectric material such as a ceramic material, a glass material, a magnetic material, a polymer material or a compound material comprising at least one of the above-mentioned dielectric materials. The radiation electrode 230 is disposed on a top surface 212 of the substrate 210, and the ground electrode 240 is disposed on a bottom surface 214 of the substrate 210. The substrate 210 comprises a through hole 216, which goes through the top and bottom surfaces 212, 214. The signal transmission unit 220 passes through and is disposed in the through hole 216. Further description of the circularly polarized antenna 200 is detailed as follows.

In the circularly polarized antenna 200, the radiation electrode 230 comprises an X-shaped central electrode 232 and four peripheral electrodes 234. The circularly polarized antenna 200 uses the X-shaped central electrode 232 to generate a circularly polarized electric field. The four peripheral electrodes 234 are respectively extended from four ends of the X-shaped central electrode 232 to adjust (e.g. to pull down) the resonant frequency thereby achieving the design requirement. In practice, the lengths and widths for four peripheral electrodes 234 can be different from one another. When the peripheral electrodes 234 are all extended along the same axis, the substrate 210 can be an oblong substrate, such as a long rectangular substrate. In this manner, the circularly polarized antenna 200 of the present invention is able to be disposed in a wafer thin mobile phone while the circular polarization characteristics are still preserved, thereby solving the problem described in the prior art.

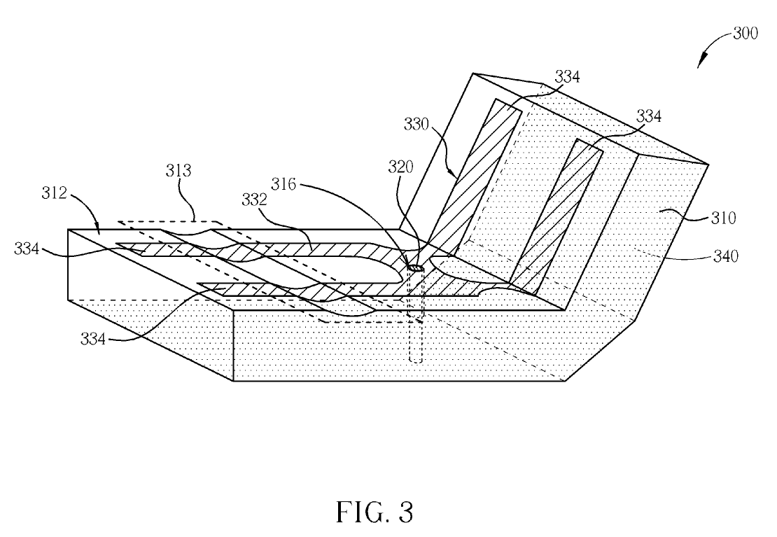

In another embodiment of the present invention, the substrate 210 of the circularly polarized antenna 200 can be a bent substrate, and the surface of the substrate 210 can be a non-flat surface. For example, please refer to FIG. 3. FIG. 3 is a schematic diagram illustrating a circularly polarized antenna according to a second embodiment of the present invention. The circularly polarized antenna 300 comprises a substrate 310, a signal transmission unit 320, a radiation electrode 330 and a ground electrode 340. The substrate 310 comprises a through hole 316, and the radiation electrode 330 comprises a central electrode 332 and a plurality of peripheral electrodes 334. As shown in FIG. 3, the substrate 310 of the circularly polarized antenna 300 is bent, and a top surface 312 of the substrate 310 is a concave non-flat surface 313. Please note that the substrate 310 can be bent in the form of an L-shape in another embodiment of the present invention, and this alternative design also falls within the scope of the present invention.

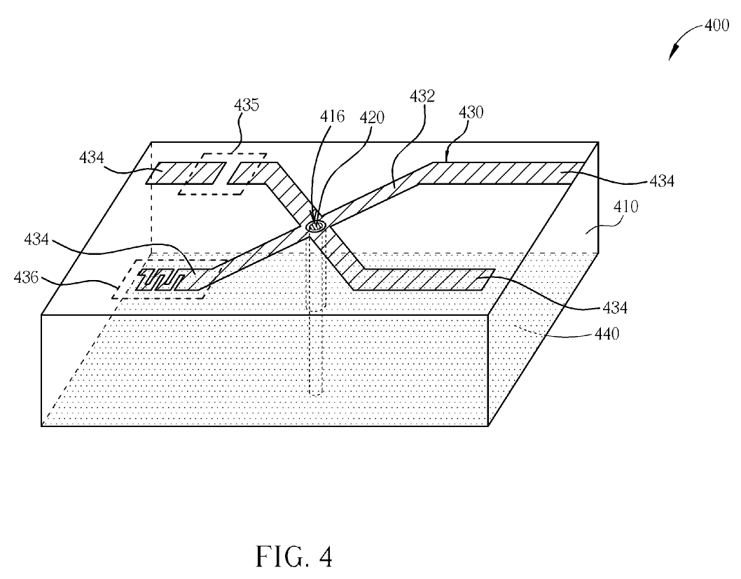

In another embodiment of the present invention, the peripheral electrodes 234 of the circularly polarized antenna 200 can comprise one or more characteristic-setting elements to adjust the capacitance or inductance, so as to form matched impedance. For an illustration of this, please refer to FIG. 4. FIG. 4 is a schematic diagram illustrating a circularly polarized antenna according to a third embodiment of the present invention. The circularly polarized antenna 400 comprises a substrate 410, a signal transmission unit 420, a radiation electrode 430 and a ground electrode 440. The substrate 410 comprises a through hole 416, and the radiation electrode 430 comprises a central electrode 432 and a plurality of peripheral electrodes 434. As shown in FIG. 4, the circularly polarized antenna 400 further comprises a gap 435 as a capacitance-setting element for adjusting the capacitance and a coil electrode 436 as an inductance-setting element for adjusting the inductance, so as to form a matched impedance. In other embodiments of the present invention, changing the width of the peripheral electrodes 234 to adjust the inductance or disposing one or more grooves on central electrode 232 to adjust the capacitance is also able to form a matched impedance for the circularly polarized antenna 200, and this alternative design also falls within the scope of the present invention.

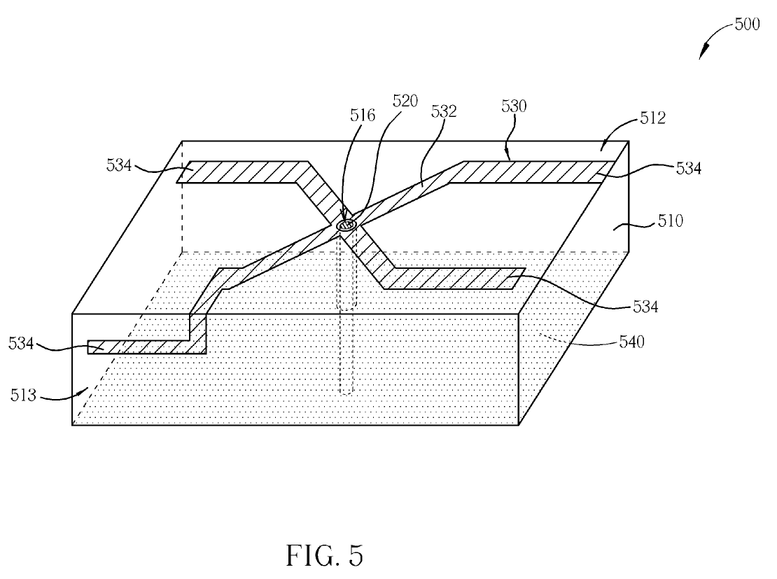

In another embodiment of the present invention, the peripheral electrodes 234 of the circularly polarized antenna 200 can be extended from the top surface 212 to a side surface of the substrate 210. For an illustration of this, please refer to FIG. 5. FIG. 5 is a schematic diagram illustrating a circularly polarized antenna according to a fourth embodiment of the present invention. The circularly polarized antenna 500 comprises a substrate 510, a signal transmission unit 520, a radiation electrode 530 and a ground electrode 540. The substrate 510 comprises a through hole 516, and the radiation electrode 530 comprises a central electrode 532 and a plurality of peripheral electrodes 534. As shown in FIG. 5, the radiation electrode 534 is extended from atop surface 512 to a side surface 513 of the substrate 510.

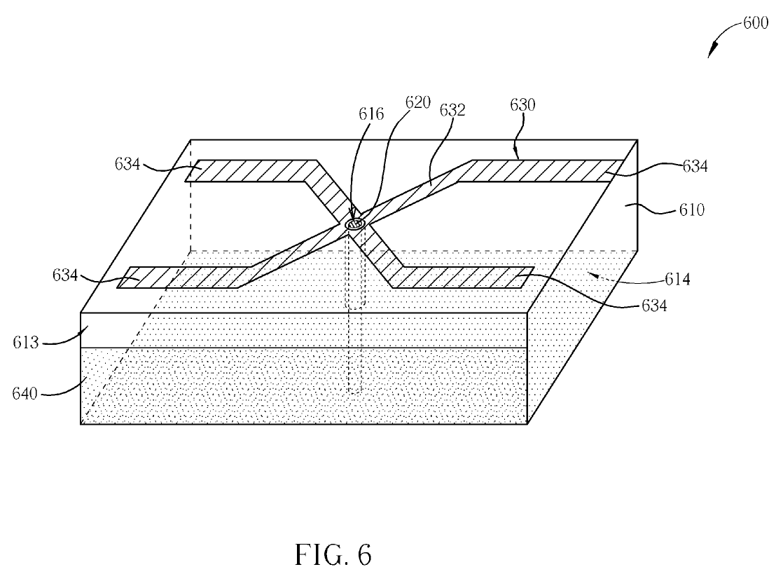

In addition, in another embodiment of the present invention, the ground electrode 240 of the circularly polarized antenna 200 can be extended from the bottom surface 214 to a side surface of the substrate 210. For an illustration of this, please refer to FIG. 6. FIG. 6 is a schematic diagram illustrating a circularly polarized antenna according to a fifth embodiment of the present invention. The circularly polarized antenna 600 comprises a substrate 610, a signal transmission unit 620, a radiation electrode 630 and a ground electrode 640. The substrate 610 comprises a through hole 616, and the radiation electrode 630 comprises a central electrode 632 and a plurality of peripheral electrodes 634. As shown in FIG. 6, the ground electrode 640 is extended from a bottom surface 614 to a side surface 613 of the substrate 610.

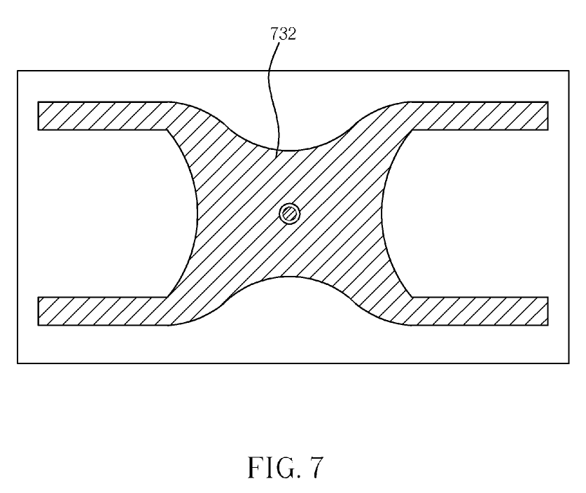

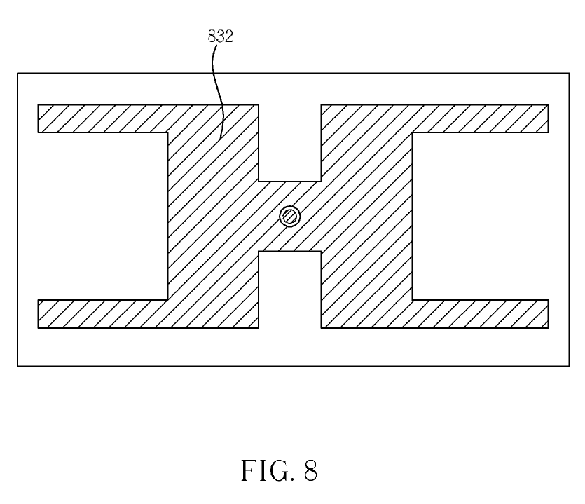

Please note that the shape of the central electrode of the present invention is not limited to the shape of the central electrode 232 shown in FIG. 2. In the present invention, the X-shaped central electrode refers to any electrode with a crossed-shape central electrode. For an illustration of this, please refer to FIG. 7 and FIG. 8. FIG. 7 is an exemplary diagram illustrating a central electrode in the shape of an X, and FIG. 8 is another exemplary diagram illustrating a central electrode in the shape of an X. As shown in FIG. 7 and FIG. 8, X-shaped central electrodes 732, 832 are both crossed-shape central electrodes.

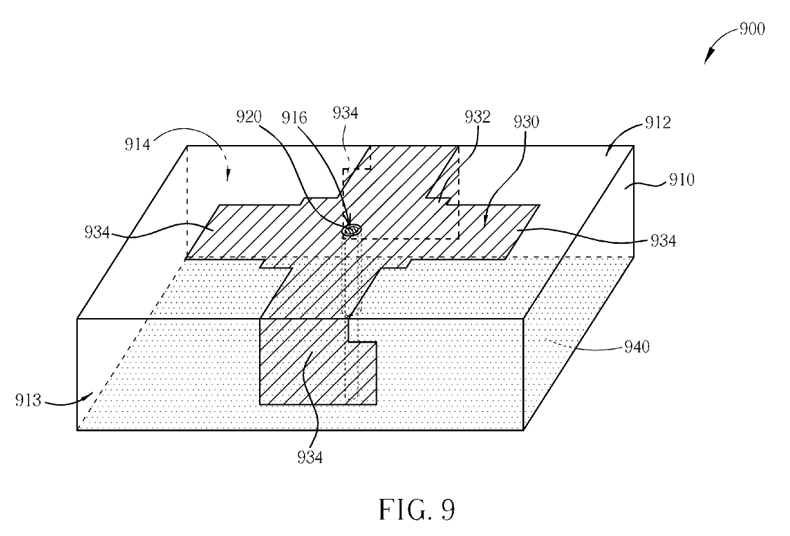

In addition, various shapes of the central electrode (e.g. circular or rectangular) that are capable of generating a circularly polarized electric field also fall within the scope of the present invention. For example, please refer to FIG. 9. FIG. 9 is an exemplary diagram illustrating a circularly polarized antenna with a rectangular central electrode of the present invention.

The circularly polarized antenna 900 comprises a substrate 910, a signal transmission unit 920, a radiation electrode 930 and a ground electrode 940. The substrate 910 comprises a through hole 916, and the radiation electrode 930 comprises a central electrode 932 and a plurality of peripheral electrodes 934. As shown in FIG. 9, the central electrode 932 in the radiation electrode 930 is rectangular; the peripheral electrodes 934 in the radiation electrode 930 extend from the central electrode 932; and several of the peripheral electrodes 934 are further extended from a top surface 912 of the substrate 910 to side surfaces 913, 914 of the substrate 910. In addition, in the side surfaces 913, 914, the peripheral electrodes 934 are extended outward to adjust the resonant frequency thereby achieving the design requirements.

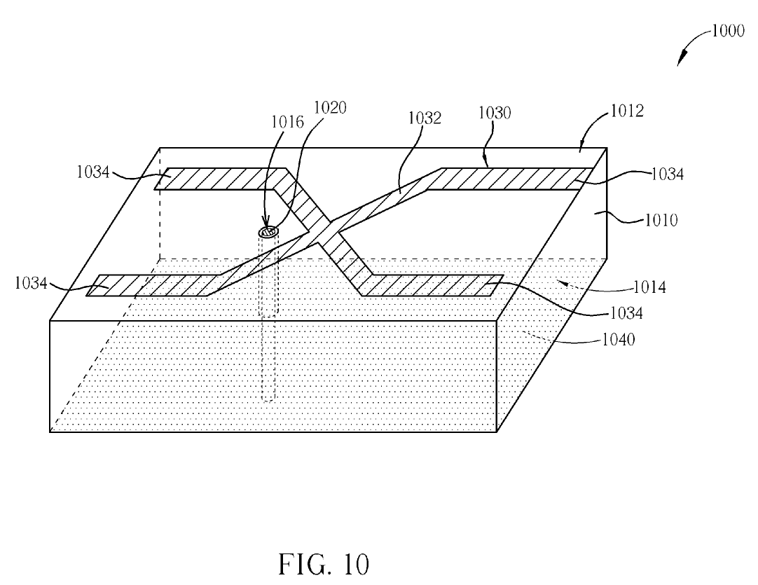

In the circularly polarized antenna 200, the through hole 216 is disposed around the center of the substrate 210 and goes through the radiation electrode 230; however, this is not a limitation of the present invention. In another embodiment of the present invention, the through hole 216 can be disposed around the center of the substrate 210 but does not go through the radiation electrode 230. For example, please refer to FIG. 10. FIG. 10 is a schematic diagram illustrating a circularly polarized antenna according to a sixth embodiment of the present invention. The circularly polarized antenna 1000 comprises a substrate 1010, a signal transmission unit 1020, a radiation electrode 1030 and a ground electrode 1040. The substrate 1010 comprises a through hole 1016, and the radiation electrode 1030 comprises a central electrode 1032 and a plurality of peripheral electrodes 1034. As shown in FIG. 10, the through hole 1016 is disposed around the center of the substrate 1010 but does not directly connect with the radiation electrode 1030 (the central electrode 1032). The signal transmission unit 1020 goes through the through hole 1016 and is disposed in the through hole 1016.

Those skilled in the art will readily observe that numerous modifications and alterations of the device and method may be made while retaining the teachings of the invention.

What is claimed is:

1. A circularly polarized antenna, comprising:
a substrate, made of a dielectric material, having a through hole through both a first surface and a second surface of the substrate;
a signal transmission unit, going through the through hole of the substrate;
a radiation electrode, disposed on the first surface of the substrate, wherein the radiation electrode comprises a central electrode and a plurality of peripheral electrodes where the plurality of peripheral electrodes are extended from the central electrode; and
a ground electrode, disposed on the second surface of the substrate.

2. The circularly polarized antenna of claim 1, wherein the central electrode is in the shape of an X.

3. The circularly polarized antenna of claim 1, wherein the central electrode is in the shape of a circle or a rectangle.

4. The circularly polarized antenna of claim 1, wherein the central electrode comprises at least one groove.

5. The circularly polarized antenna of claim 1, wherein the substrate is an oblong substrate.

6. The circularly polarized antenna of claim 1, wherein the substrate is a rectangular substrate.

7. The circularly polarized antenna of claim 1, wherein the substrate is a bent substrate.

8. The circularly polarized antenna of claim 1, wherein the substrate is a bent substrate in the form of an L-shape.

9. The circularly polarized antenna of claim 1, wherein at least one of the peripheral electrodes comprises a characteristics-setting element.

10. The circularly polarized antenna of claim 9, wherein the characteristics-setting element is a capacitance-setting element.

11. The circularly polarized antenna of claim 9, wherein the characteristics-setting element is an inductance-setting element.

12. The circularly polarized antenna of claim 1, wherein at least one of the peripheral electrodes is extended from the first surface of the substrate to a third surface of the substrate.

13. The circularly polarized antenna of claim 1, wherein the ground electrode is extended from the second surface of the substrate to a third surface of the substrate.

14. The circularly polarized antenna of claim 1, wherein the through hole goes through the radiation electrode.

15. The circularly polarized antenna of claim 1, wherein the through hole does not go through the radiation electrode.

16. The circularly polarized antenna of claim 1, being a patch antenna.

17. The circularly polarized antenna of claim 1, wherein the dielectric material of the substrate is a glass material or a ceramic material.

18. The circularly polarized antenna of claim 1, wherein the dielectric material of the substrate is a polymer material.

19. The circularly polarized antenna of claim 1, wherein the dielectric material of the substrate is a magnetic material.

20. The circularly polarized antenna of claim 1, wherein the dielectric material of the substrate is a compound material comprising at least one of glass, ceramic, polymer and magnetic materials.
